(19) United States
(12) Patent Application Publication
(10) Pub. No.: US 2021/0201110 A1
(43) Pub. Date: Jul. 1, 2021

(54) METHODS AND SYSTEMS FOR PERFORMING INFERENCE WITH A NEURAL NETWORK

(71) Applicant: ALIBABA GROUP HOLDING LIMITED, George Town (KY)

(72) Inventor: Minghai QIN, San Mateo, CA (US)

(21) Appl. No.: 16/731,444

(22) Filed: Dec. 31, 2019

(51) Int. Cl. G06N 3/04; G06N 3/08; G06N 3/10

(52) U.S. Cl. CPC G06N 3/04; G06N 3/10; G06N 3/08

(57) ABSTRACT

The present disclosure provides methods, systems, and non-transitory computer readable media for performing inference with a neural network. The systems include one or more processing units configured to instantiate a neural network comprising a bypass switch that is associated with at least two bypass networks, wherein each of the at least two bypass networks have at least one hidden layer, the bypass switch is configured to select a bypass network of the at least two bypass networks to activate, and any non-selected bypass network of the at least two bypass networks is not activated.

### TECHNICAL FIELD

The present disclosure generally relates to machine learning, and more particularly, to methods, systems, and non-transitory computer readable media for performing inference with a neural network.

### BACKGROUND

Machine learning systems play an integral role in enabling electronics to accomplish previously unachievable tasks. Machine learning enables electronics to accomplish numerous valuable tasks previously not possible, such as voice recognition, natural language processing, and autonomous navigation. As such, models trained using machine learning have proliferated to appear across a wide variety of devices for a variety of purposes. However, models trained via machine learning tend to be resource intensive, leading to problems when deployed on resource-constrained devices.

### SUMMARY OF THE DISCLOSURE

The embodiments of the present disclosure provide methods, systems, and non-transitory computer readable media for performing inference with a neural network. The systems include one or more processing units configured to instantiate a neural network comprising a bypass switch that is associated with at least two bypass networks, wherein each of the at least two bypass networks have at least one hidden layer, the bypass switch is configured to select a bypass network of the at least two bypass networks to activate, and any non-selected bypass network of the at least two bypass networks is not activated.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that the foregoing general description and the following detailed description are exemplary and explanatory only, and are not restrictive of the invention, as claimed.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates a simplified schematic diagram illustrating an artificial neuron, according to some embodiments of the present disclosure.

FIG. 2 illustrates a simplified diagram of an artificial neural network, according to some embodiments of the present disclosure.

FIG. 3 illustrates an alternative schematic diagram of an artificial neural network, according to some embodiments of the present disclosure.

FIG. 4 illustrates an overview of an artificial neural network, according to some embodiments of the present disclosure.

FIG. 5 illustrates a schematic diagram of a bypass block, according to some embodiments of the present disclosure.

FIG. 6 illustrates an alternative schematic diagram of a bypass block, according to some embodiments of the present disclosure.

FIG. 7 illustrates a schematic diagram of a bypass switch, according to some embodiments of the present disclosure.

FIG. 8 illustrates an example of the connectivity between bypass blocks, according to some embodiments of the present disclosure.

FIG. 9 illustrates an additional example of the connectivity between bypass blocks, according to some embodiments of the present disclosure.

FIG. 10 is a flowchart demonstrating how an artificial neural network may change a selected bypass network based on monitored performance metrics, according to some embodiments of the present disclosure.

FIG. 11 is a flowchart demonstrating how an artificial neural network may change a selected bypass network based on monitored observables, according to some embodiments of the present disclosure.

FIG. 12 illustrates an exemplary neural network processing architecture, according to some embodiments of the present disclosure.

FIG. 13 illustrates an exemplary accelerator core architecture, according to some embodiments of the present disclosure.

FIG. 14 illustrates another exemplary neural network processing architecture, according to some embodiments of the present disclosure.

FIG. 15 illustrates a schematic diagram of an exemplary cloud system incorporating a neural network processing architecture, according to some embodiments of the present disclosure.

FIG. 16 is a flowchart demonstrating how an artificial neural network with at least one bypass block could be trained, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Machine learning refers to a discipline of computer science that deals with algorithms and systems that can “learn” to perform a task or solve a problem without being explicitly instructed how to do so. Broadly speaking, a machine learning system can “learn” how to solve a task by relying on patterns and inferences derived from data related to the task in some way. This data is usually referred to as training data and is often analogized as being like “experience.” In more formal terms, machine learning concerns the study of machine learning algorithms, which are algorithms that, given a task and relevant training data, create or modify a mathematical model able to solve the desired task. The process of a machine learning algorithm creating a model from training data is usually referred to as “training,” and the model resulting from “training” is usually referred to as a “trained model.” This highlights the importance distinction between machine learning algorithms and the trained models that machine learning algorithms create. In most cases, when “machine learning” is employed to accomplish a task on a device, it is only a trained model created by a machine learning algorithm that is being used and not any type of machine learning algorithm.

There are a variety of approaches in the field of machine learning for creating a machine learning system. One of the most important dimensions on which these approaches vary are the type of mathematical model the machine learning algorithm modifies. The choice of model impacts numerous performance characteristics of the resulting machine learning system, including the time and training data needed to create a trained model, but also the speed, reliability, and accuracy of the resulting trained model itself. In recent years, by far the most popular type of mathematical model to use for machine learning is an artificial neural network.

As implied by their name, artificial neural networks (ANNs) refer to a type of mathematical model inspired by the biological neural networks of human brains. At a conceptual level, an artificial neural network is a collection of connected units called artificial neurons. Like biological neurons, artificial neurons usually have various one-way connections, called edges, to other artificial neurons. Each artificial neuron may have connections to the output of other artificial neurons—analogous to dendrite of a biological neuron—and may have connections to the inputs of other artificial neurons—analogous to the axon of a biological neuron. Each artificial neuron can receive signals from the output of the other artificial neurons it is connected to, processing those signals, and then sending a signal of its own based on the signals it received. In this way, signals in an artificial neural network propagate between the artificial neurons composing the artificial neural network.

In a typical artificial neural network, each edge can convey a signal, with the signal usually being represented by a real number. Additionally, each edge typically has an associated weight, which is a measure of the strength of the connection represented by the corresponding edge. Typically, the weight of an edge is also represented by a real number. The way a weight is usually applied is that any incoming signal is multiplied by the weight of the edge the signal is being conveyed on, with the resulting product being what is used by the artificial neuron to determine its output signal. More specifically, in a typical artificial neural network, all incoming signals, after being multiplied by the weights of their respective edges, are summed together, with the resulting sum being used as the input to a function known as the activation function. The activation function is a (typically non-linear) function whose output is used as the output signal for an artificial neuron. Thus, the output of an artificial neuron is usually the evaluation of the activation function for the value of the sum of the incoming signals. In mathematical terms, if xᵢ and wᵢ equal the i-th signal and weight, respectively, then the output of an artificial neuron is ƒ(Σᵢ₌₁ⁿxᵢwᵢ), where ƒ is the activation function. Of course, while this is the conceptual representation of an artificial neural network, the physical implementation of an artificial neural network may differ. For example, artificial neural networks are often represented as matrixes, with the operations described above being implemented by operations on and between the matrixes.

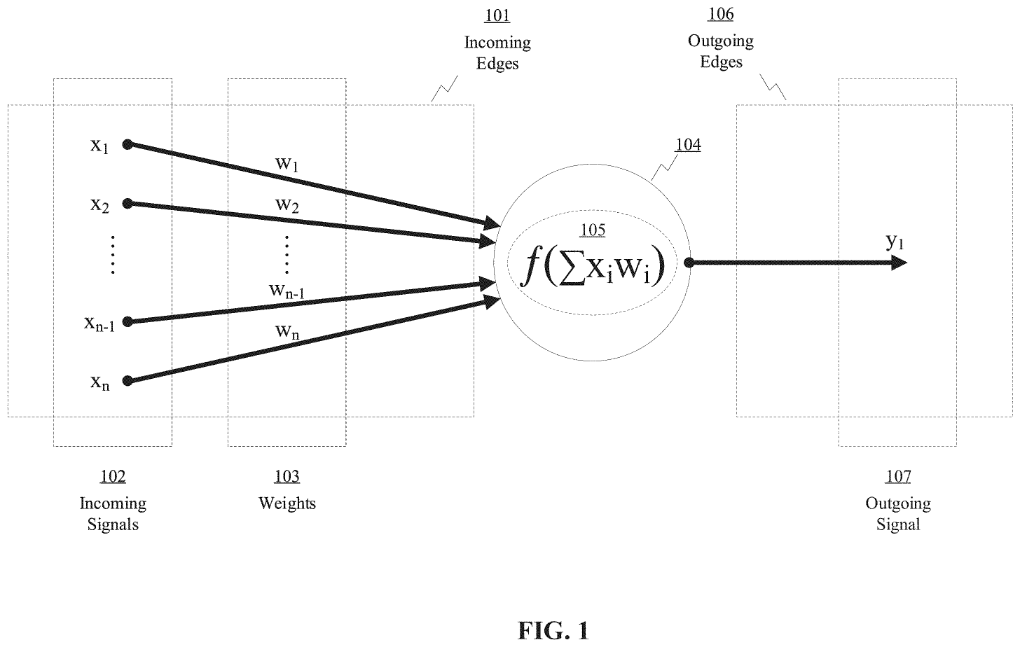

FIG. 1 is a simplified diagram illustrating an artificial neuron as just described. According to FIG. 1, artificial neuron 104 has incoming edges 101 and outgoing edges 106. Each incoming edge 101 may propagate an incoming signal 102, represented as x₁ through xₙ, to artificial neuron 103. Typically, incoming signals 102 are represented as real numbers, but in general incoming signals 102 could be represented by a variety of data types. As further shown in FIG. 1, the incoming edges 101 have weights 103 associated with them, represented as w₁ through wₙ. Typically, weights 103 are represented as a real number and signify the strength of the corresponding incoming edges 101. Artificial neuron 104 also has an outgoing edge 106, which conveys the outgoing signal 107 of artificial neuron 104 to the other artificial neurons that artificial neuron 104 is connected to. In general, the outgoing signal 107 of artificial neuron 104 is based on an activation function, represented in FIG. 1 as ƒ. Usually, the output function is based on some combination of the incoming signals 102.

FIG. 1 also shows a common way that incoming signals 102 are combined. Specifically, the equation 105 illustrated within artificial neuron 104 indicates that each incoming signal 102 is multiplied by a weight 103 associated with the corresponding incoming edge 101. The product of each incoming signal 102 and weight 103 are then summed together, with the resulting sum being used as input to activation function ƒ. The result of activation function ƒ for the sum is then used as the outgoing signal 107 for outgoing edge 104 of artificial neuron 104.

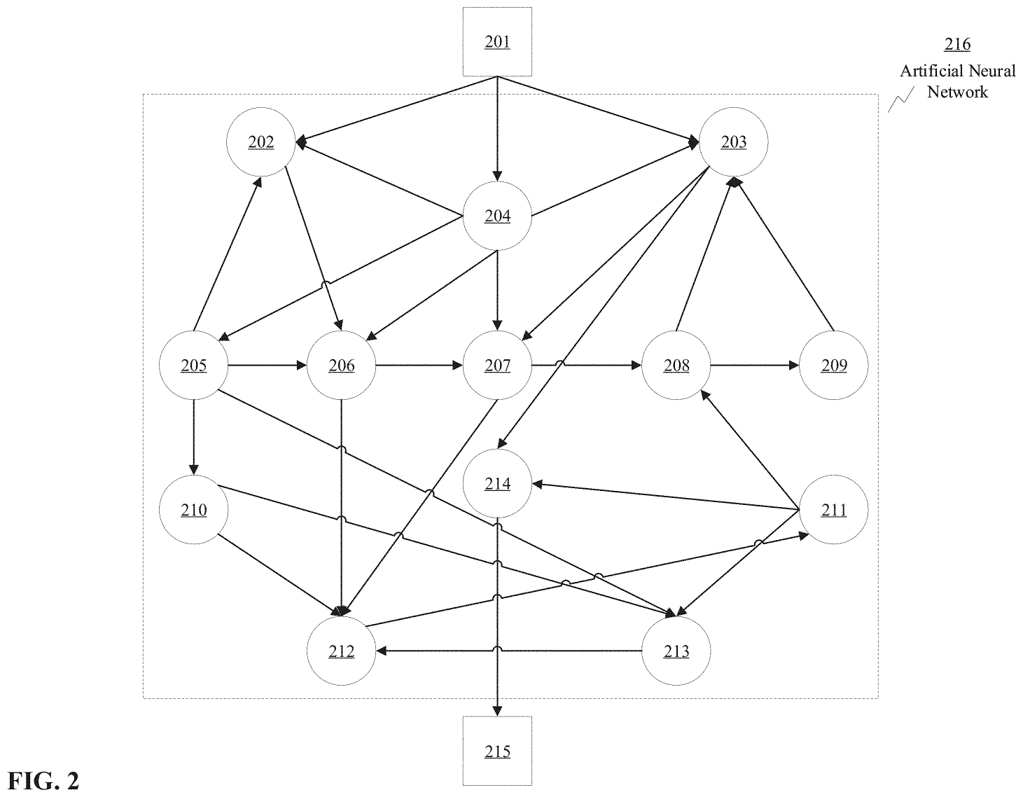

FIG. 2 is a simplified diagram illustrating an exemplary artificial neural network as described above. According to FIG. 2, artificial neural network 216 is composed of artificial neurons 202, 203, 204, 205, 206, 207, 208, 209, 210, 211, 212, 213, and 214. Artificial neurons 202, 203, 204, 205, 206, 207, 208, 209, 210, 211, 212, 213, and 214 have incoming edges, represented as a directed arrow towards the artificial neuron, and have outgoing edges, represented as a directed arrow away from the artificial neuron. Taking artificial neuron 206 as an example, artificial neuron 206 has incoming edges from artificial neurons 202, 204, and 205 and has outgoing edges to artificial neurons 207 and 212. Also shown are input 201, which provides artificial neural network 216 with its initial input, and output 215, which receives the output of artificial neural network 216. Note that while FIG. 2 illustrates an artificial neural network—e.g., as a directed graph where the nodes are artificial neurons and there are not restrictions imposed on the connections between artificial neurons—the artificial neural network lacks higher order features typically found in artificial neural networks used for machine learning, most notably the presence of layers.

While not required, in practice most artificial neural networks have higher-level structure than just individual artificial neurons. Most artificial neural networks have artificial neurons aggregated into layers, with the defining characteristic of a layer usually being that artificial neurons within the same layer do not have edges between themselves. For most artificial neural networks, there are two layers given special designations, those layers being known as the input layer and the output layer (note that, though referred to in the singular, some artificial neural networks may have more than one input layer or output layer). The input layer is special because the edges to artificial neurons in the input layer typically propagate signals representing the input to be processed by the entire artificial neural network. Similarly, the output layer is special because the edges from the artificial neurons in the output layer typically propagate a signal representing the output of the entire artificial neural network. The layers of artificial neurons between the input layer and output layer are typically referred to as hidden layers.

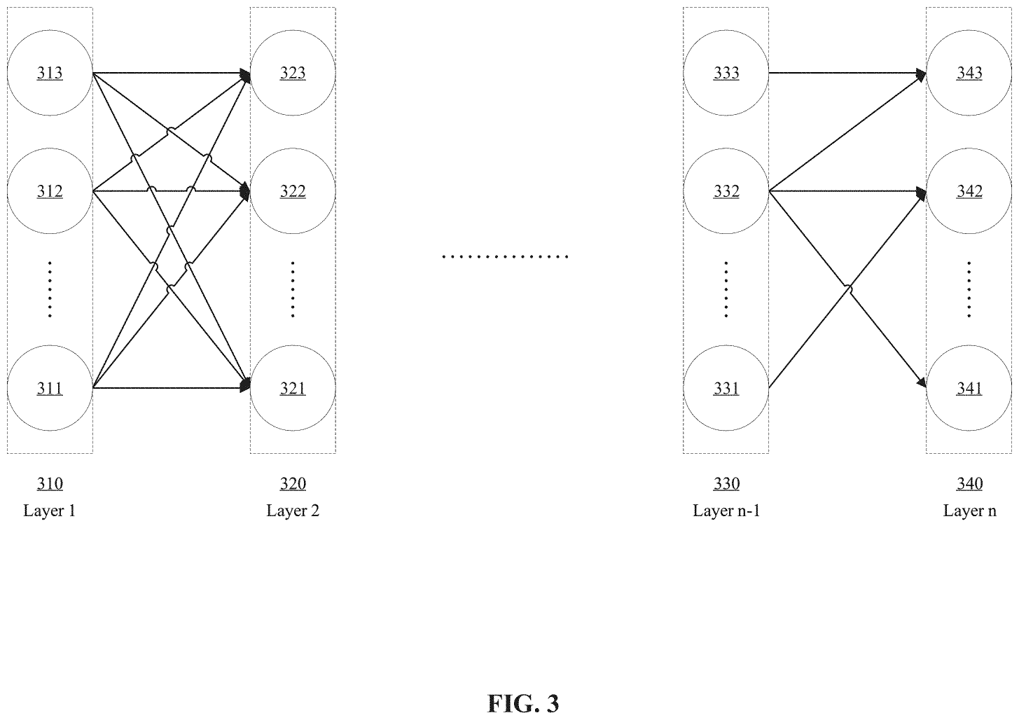

FIG. 3 is a simplified diagram illustrating an artificial neural network which has artificial neurons aggregated into layers. According to FIG. 3, the artificial neural network may be composed of several layers, shown in FIG. 3 as layers 310, 320, 330, and 340. Each layer is then composed of one or more artificial neurons. Taking layer 310 as an example, layer 310 is composed of artificial neurons 311, 312, and 313. In general, the artificial neurons in a layer have connections to artificial neurons in one or more other layers. Taking artificial neuron 313 of layer 310 as an example, artificial neuron 313 has outgoing edges to artificial neurons 321, 322, and 323 of layer 320. Note that, FIG. 3 as illustrated is an example of a feed-forward artificial neural network, where artificial neurons in each layer only have outgoing edges to artificial neurons in the subsequent layer and only have incoming edges from artificial neurons in the previous layer. For a general artificial neural network, this may not be the case, and the artificial neurons in one layer can have both incoming and outgoing edges to artificial neurons in other layers.

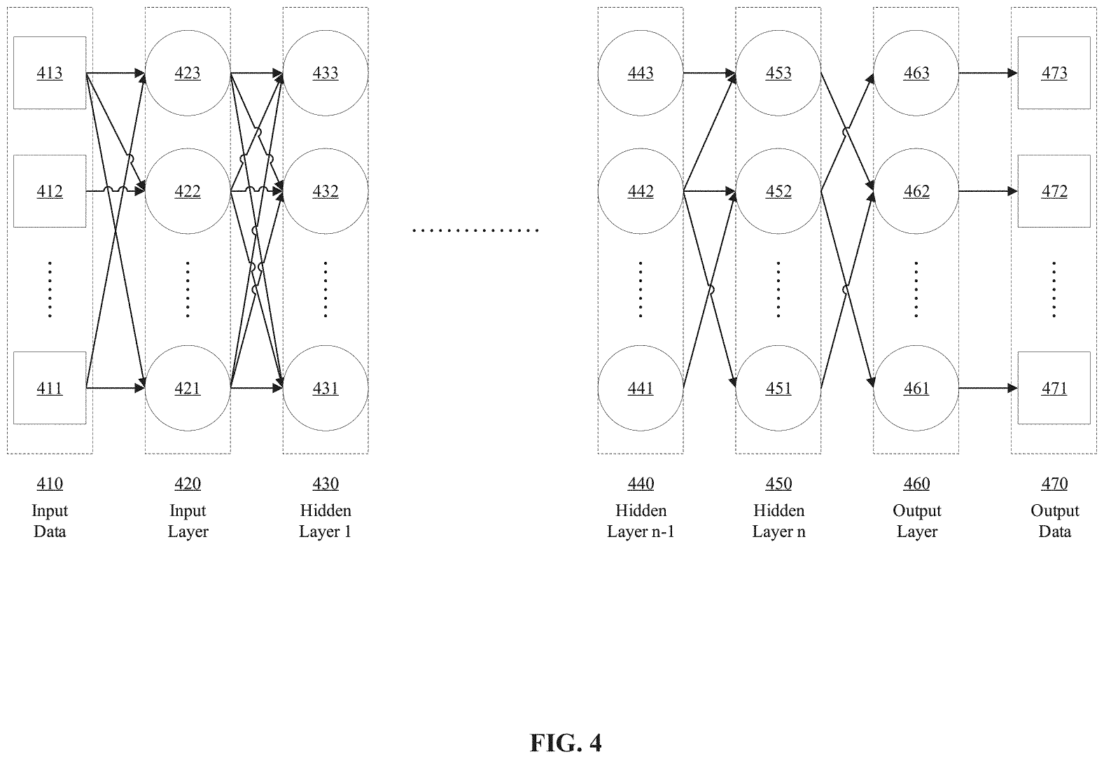

FIG. 4 is also a simplified diagram illustrating an artificial neural network and illustrates the use of an input layer, an output layer, and one or more hidden layers. Specifically, FIG. 4 shows an artificial neural network composed of one or more layers, shown here as input layer 420, output layer 460, and hidden layers 430, 440, and 450. Each layer is again composed of one or more artificial neurons, as shown by hidden layer 430, which is composed of artificial neurons 431, 432, and 433. Also shown is input data 410, which is an input given to the artificial neural network for processing, and output data 470, which is the output from the artificial neural network after processing the input. Input layer 420 is the first layer and has incoming edges directly from the input data 410. Similarly, output layer 460 has outgoing edges to output data 470. Hidden layers 430, 440, and 450 are those layers of artificial neurons between input layer 420 and output layer 460.

Artificial neurons are grouped into layers for a variety of technical reasons. As is relevant here, one of the most important reasons for grouping artificial neurons into layers is that it makes training an artificial neural network easier. Usually, increasing the number of artificial neurons increases the accuracy and expands the scope of problems an artificial network can. However, increasing the number of artificial neurons has the drawback that it typically makes training slower and more resource intensive. Among other benefits, grouping artificial neurons into layers partially offsets this increase in cost to train an artificial neural network. This allows larger and more capable artificial neural networks to be created and used.

In recent years, trained models based on artificial neural networks have been become widely deployed for a variety of tasks. The widespread use of artificial neural networks is largely attributable to their ability to “learn” how to perform a task from examples rather than requiring explicit, step-by-step programming. This has allowed artificial neural networks to successfully handle tasks previously not understood well enough to be amenable to explicit programing, such as image recognition, speech recognition, and natural language processing. While first hosted in datacenters, the utility of artificial neural networks has led to a desire to host them closer to end user devices, with the ideal goal being hosting the artificial neural network on the user's device itself. While advances in both the underlying hardware and in the efficiency of trained artificial neural networks have assisted with this desire, artificial neural networks remain quite resource intensive. This leads to unique challenges when artificial neural networks are sought to be deployed on devices that have significant resource constraints. There are a wide variety of resource constraints a device could face, such as having limited energy, limited energy flow, limited processing power, or some type of time constraints. A wide variety of devices face these limitations. These devices tend to be smaller and usually, though not always, rely on battery power. Examples include various internet of things (IoT) devices, embedded systems, and smaller electronics, like smartphones and wearable devices.

To successfully enable the use of artificial neural networks on these resource-constrained devices, the resource-consumption of an artificial neural network can be carefully balanced with the resource-budget of the host device to ensure adequate performance without exhausting (or exceeding) the resources of the devices' resources. Further complicating this balancing is the fact that both the resources available to the host device and the resources consumed by an artificial neural network in processing an input can vary. Worse still, the nature of artificial neural networks makes managing the artificial neural networks' resource-consumption difficult. Typically, an artificial neural network cannot be altered after it is deployed. Or, more accurately, an artificial neural network would have to be retrained in order to be altered after it is deployed, which would consume orders of magnitude more resources than using the artificial neural network for inferencing and would take timescales too long for use in dynamically adjusting the artificial neural networks performance. To understand why, it is useful to understand the distinction between the two chief phases of an artificial neural network model's lifetime: training and inference. During the training phase, an artificial neural network is adjusted so that is accurately completes a target task. This phase is often extremely resource-intensive, particularly for artificial neural networks with many hidden layers. Once an artificial neural network is adequately trained, it is then deployed in what is called the inference phase. During the inference phase, the artificial neural network is used to solve the problem it was trained on; the artificial neural network is given inputs and provides an output achieving the task the neural network was trained to accomplish. Inference, while still often resource-intensive, is orders-of-magnitude less resource intensive than training. Thus, dynamically retraining an artificial neural network is usually not practicable, particularly on devices whose resource-constraints require managing the resource-consumption of merely using an artificial neural network for inferencing.

Because of the difficulty in altering a deployed artificial neural network in order to modulate its resource consumption, previous solutions to the problem of managing the resource consumption of an artificial neural network have revolved around the use of multiple artificial neural networks. These artificial neural networks are trained to solve the same problem, but they make different tradeoffs between accuracy and resource-utilization. This may be accomplished, for example, by having some artificial neural networks possess more artificial neurons and other artificial neural networks possess fewer artificial neurons. This allows some artificial neural networks to be less accurate but correspondingly less resource-intensive and allows others to be more accurate but correspondingly consume more resources. The host device selects the artificial neural network from these artificial neural networks with the resource-consumption appropriate to the resources the host device currently has available.

The strategy of using multiple artificial neural networks of varying complexity is inefficient, however. As an initial matter, training multiple artificial neural networks is more costly than training a single artificial neural network, raising the cost of the device. A further inefficiency is the space and resources that must be devoted to including the additional artificial neural networks on the host device. Finally, because these artificial neural networks are different, it is not possible to dynamically change an artificial neural network while it is processing an input. In other words, if an artificial neural network is consuming too many or too few resources while processing an input, either any changes must wait until the artificial neural network finished processing the input or the current work of artificial neural network in processing the input must be discarded.

To address the issue of controlling an artificial neural network's resource consumption on a resource-constrained device and to overcome the shortcomings of previous efforts, some of the disclosed embodiments present methods of dynamically controlling the resource usage of an artificial neural network. This can resolve the problems faced by resource-constrained devices by allowing dynamic modification to an artificial neural network's accuracy and resource consumption without needing to retrain the artificial neural network. Accordingly, contrary to some conventional approaches, the disclosed embodiments can achieve a better balance of an artificial neural networks resource consumption with the available resources while avoiding the waste and inefficiency of having multiple artificial neural networks for the same task.

To enable this dynamic control of resource consumption while inferencing, some of the embodiments of the present disclosure may begin processing an input with an artificial neural network. In some embodiments, this may involve the artificial neural network receiving the input at an input layer. How the artificial neural network may receive the input at the input layer may vary based on how the artificial neural network is implemented. In some embodiments, receiving the input at the input layer may involve receiving a signal from the incoming edges of the input layer. In some embodiments, receiving a signal from the incoming edges of the input layer may be represented via matrixes and operations between the matrixes. In some embodiments, receiving a signal from the incoming edges of the input layer may involve receiving an electrical signal at terminals representing the incoming edges of the artificial neurons in the input layer.

In some embodiments, the artificial neural network that is processing the input may have a plurality of hidden layers. Additionally, some embodiments may further have a plurality of connections between the plurality of hidden layers. The number of hidden layers, the number of connections between the hidden layers, and the structure or organization of the connections between the hidden layers may vary between embodiments. For example, some embodiments may have only a few hidden layers whereas other embodiments may have many hidden layers. As another example, some embodiments may have only a few connections between the hidden layers whereas other embodiments may have many connections between the hidden layers. Finally, some embodiments may have a relatively simple structure between the hidden layers whereas others may have more complex structures. For example, some embodiments may have artificial neural networks that are feed forward neural networks, where each hidden layer has connections to only the hidden layers immediately before and after itself. Some embodiments may have a more complex structure and may potentially have connections between any two hidden layers.

Additionally, some embodiments may have at least one bypass block. In some of these embodiments, a bypass block may contain a bypass switch and two or more bypass networks. In some embodiments, each bypass network may further have at least one hidden layer. A bypass network may then, in some embodiments be conceptualized as a set of one or more hidden layers. For some embodiments, a bypass block may be conceptualized as representing a choice between these two or more bypass networks, with the bypass switch, in some embodiments, representing a selector of which bypass network is to be used. In some embodiments, each bypass network may have different performance characteristics. For example, in some embodiments, one bypass network of a bypass block may have many hidden layers, and thus be very accurate but also very resource-intensive, whereas a different bypass network in the same bypass block may have few hidden layers, and thus be correspondingly less accurate but also relatively resource-light. In some embodiments, having multiple bypass networks with different performance characteristics may allow dynamic management of the resources consumed by and the accuracy of the artificial neural network.

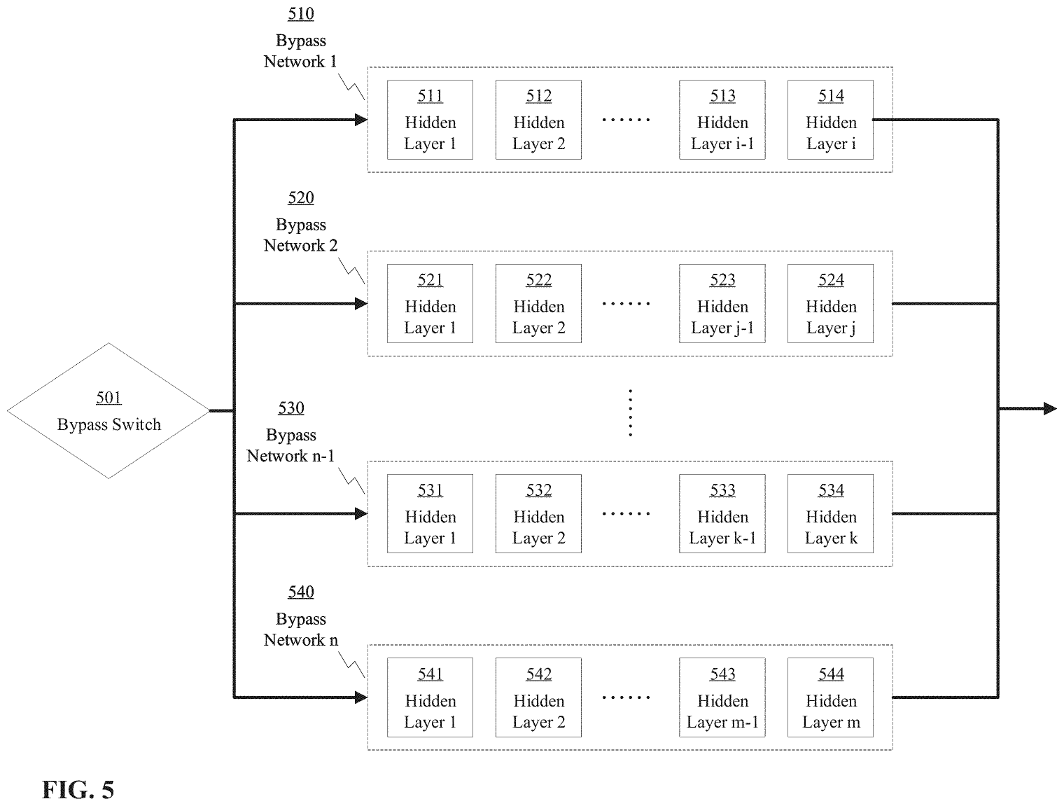

FIG. 5 is a schematic diagram illustrating a bypass block. Specifically, FIG. 5 shows a bypass block composed of a bypass switch 501 and several bypass networks, shown here as bypass networks 510, 520, 530, and 540. FIG. 5 further shows that each bypass network is composed of one or more hidden layers. Note that each bypass layer may have a different number of hidden layers, e.g., bypass network 510 may have i hidden layers, bypass network 520 may have j hidden layers, etc. Taking bypass network 510 as an example, FIG. 5 shows that bypass network 510 is comprised of hidden layers 511, 512, 513, and 514. In general, bypass switch 501 selects which of the bypass networks 510, 520, 530, and 540 is to be active. FIG. 5 illustrates this relationship by showing inputs flowing from bypass switch 501 into the bypass networks 510, 520, 530, and 540 and outputs flowing from the bypass networks 510, 520, 530, and 540.

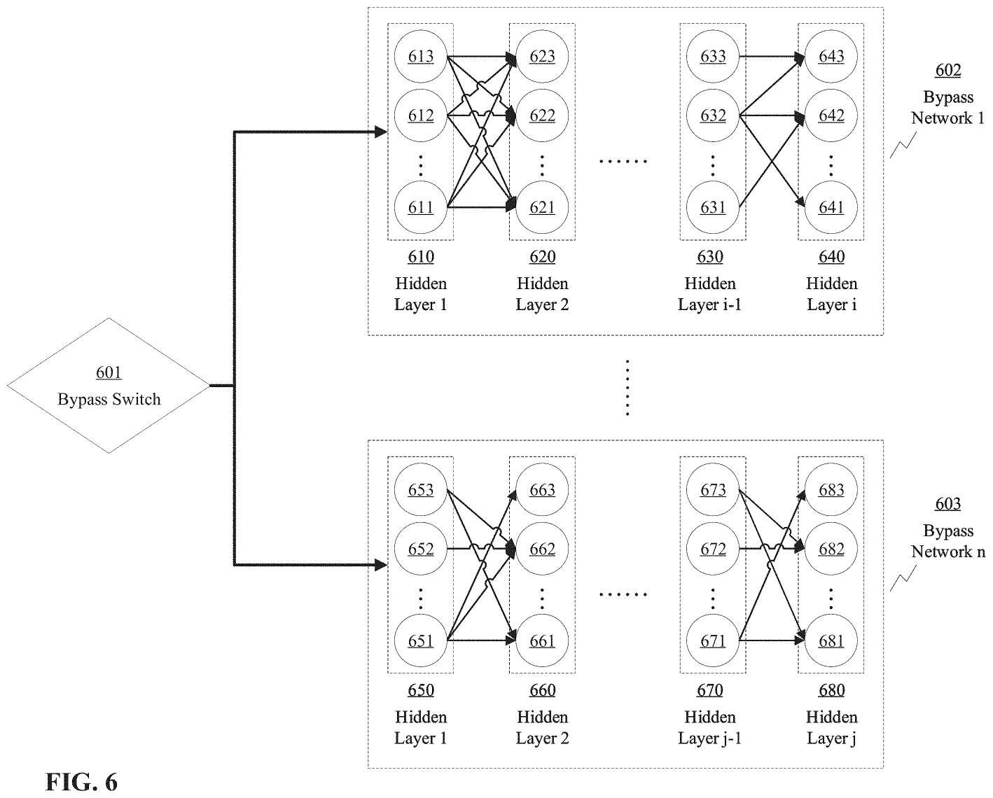

FIG. 6 is an alternative schematic diagram illustrating a bypass block. As shown in FIG. 6, a bypass block composed of a bypass switch 601 and several bypass networks, shown here as bypass networks 602 and 603. Each bypass network is further shown as being comprised of one or more hidden layers. Taking bypass network 602 as an example, FIG. 6 shows that bypass network 602 is comprised of hidden layers 610, 620, 630, and 640. Note that bypass networks 602 and 603 can each have a different number of hidden layers and can have different connections (and weights) between each hidden layer. For example, bypass network 602 may have i hidden layers whereas bypass network 603 may have j hidden layers. The first hidden layer of bypass network 602 (hidden layer 610) also has different connections that the first hidden layer of bypass network 603 (hidden layer 650).

Further shown by FIG. 6 is that each hidden layer is composed of artificial neurons, with the artificial neurons in one hidden layer having connections to artificial neurons in other hidden layers. Taking hidden layer 610 of bypass network 602 as an example, FIG. 6 shows that hidden layer 610 is composed of artificial neurons 611, 612, and 613. These artificial neurons are shown as having connections to the artificial neurons in other hidden layers. Taking artificial neuron 611 as an example, FIG. 6 shows that artificial neuron 61 has outgoing connections to artificial neurons 621, 622, and 623 of hidden layer 620.

In some embodiments, the bypass switch may select which bypass network of a bypass block is to be active. In various embodiments, a bypass switch may be implemented in a variety of ways. For example, for an embodiment where an artificial neural network is implemented in software as matrixes, a bypass switch may be a routine that determines which matrixes—representing the active bypass networks of the respective bypass block—is to be used. Additionally, in some embodiments only the connections to the hidden layers of bypass networks that are active, e.g., selected by the bypass switch, are used.

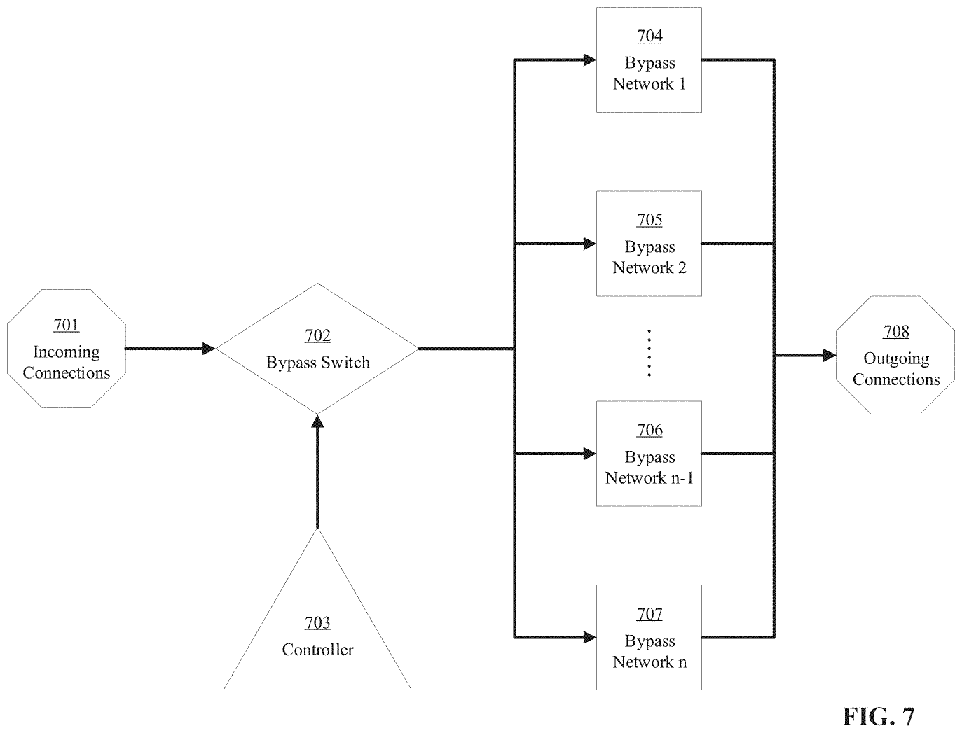

FIG. 7 is a schematic diagram illustrating a bypass switch in a bypass block. Specifically, FIG. 7 shows how a bypass switch controls which bypass networks are active and, correspondingly, which bypass networks are used. Specifically, FIG. 7 shows how bypass switch 702 controls which incoming connections 701 are used. Depending on which bypass networks, shown here as bypass networks 704, 705, 706, and 707 are active, the incoming connections 701 for those bypass blocks may be used. The networks that are activated by bypass switch 702 may be changed by a controller 703. Controller 703 could represent a variety of sources, such as a host device or a neural processing unit (NPU) controller. Similarly, FIG. 7 shows how the bypass switch 702 controls which outgoing connections 708 are used depending on which bypass network is active.

In some embodiments, each bypass block may be preceded by or followed by a group of one or more hidden layers that are not part of a bypass block. In other embodiments, bypass blocks may follow one another sequentially. In some embodiments, the artificial neural network may have both bypass blocks that are not preceded or followed by a group of one or more hidden layers that are not part of a bypass block and bypass blocks that are preceded or followed by a group of one or more hidden layers that are not part of a bypass block.

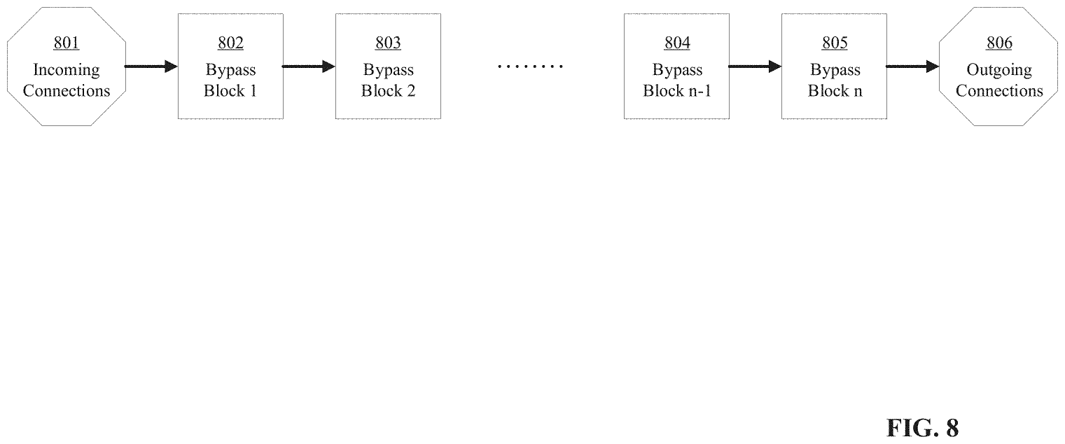

FIG. 8 is a schematic diagram illustrating a possible sequence of bypass blocks. Specifically, FIG. 8 illustrates a portion of an artificial neural network having only adjacent bypass blocks without groups of hidden layers between the bypass blocks. As shown in FIG. 8, this portion of the artificial neural network is composed of several bypass blocks, shown here as bypass blocks 802, 803, 804, and 805. Bypass block 802 has incoming connections from the rest of the artificial neural network, and bypass block 805 has outgoing connections to the rest of the artificial neural network. A signal may propagate to bypass block 802, through the active bypass network, and then the output of bypass block 802 may propagate to bypass block 803. This process may repeat until the output of bypass block 805 propagates to the rest of the artificial neural network.

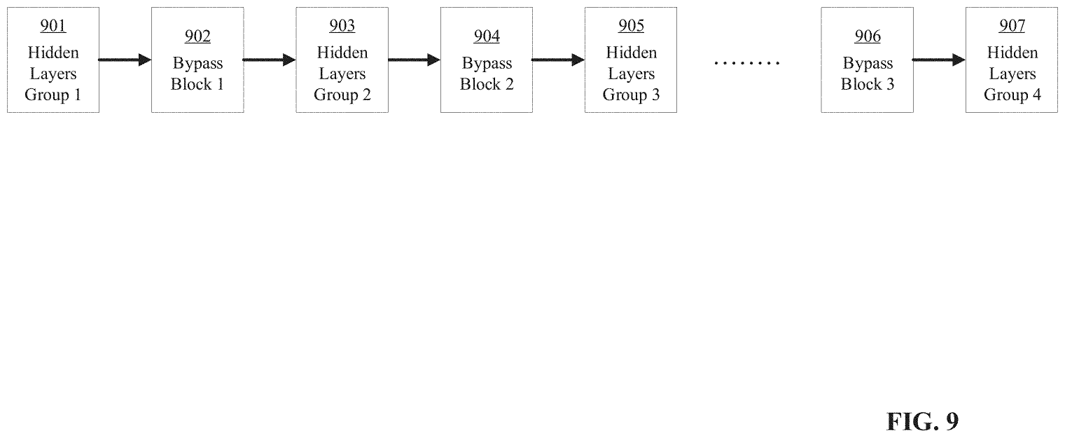

FIG. 9 is also a schematic diagram illustrating a possible sequence of bypass blocks. Specifically, FIG. 9 illustrates a portion of an artificial neural network where the bypass blocks are preceded and followed by a group of one or more hidden layers. As shown in FIG. 9, this portion of the artificial neural network is composed of several bypass blocks, shown as bypass blocks 902, 904, and 906, and several hidden layer groups, shown here as hidden layer groups 901, 903, 905, and 907. Bypass block 902 has incoming connections from hidden layers group 901 and outgoing connections to hidden layers group 903. Similarly, bypass block 904 has incoming connections from hidden layers group 903 and outgoing connections to hidden layers group 905. Bypass block 906 is shown as having outgoing connections to hidden layers group 907. A signal may propagate to hidden layers group 901, through bypass block 902 and its active bypass network, and then through hidden layers group 903. This process may repeat until the output of hidden layers group 907 propagates to the rest of the artificial neural network.

In some embodiments, the bypass switch of a bypass block may be set, causing the bypass switch to select one or more bypass networks which, in some embodiments, may cause the selected bypass networks to be activated. When the bypass switch of a bypass block is set may vary between embodiments. For example, in some embodiments the bypass switch may be set while the artificial neural network is processing an input. In some other embodiments, the bypass switch may be set before or after the artificial neural network is processing an input. Additionally, in some embodiments, the bypass switch may be set for every evaluation of an input. In some other embodiments, the bypass switch may be set on a schedule different from one or more times for every input, such as the bypass switch being set after processing some number of inputs, the bypass switch being set because of the occurrence of some event, the meeting of some threshold, or the exceeding of some performance metric, or some other monitoring strategy. Some embodiments may also set a bypass block more than once while the artificial neural network is processing an input. Finally, some embodiments may employ a combination of the above strategies, may change the strategies or mix of strategies depending on the circumstances at a given instance, and may employ different strategies simultaneously for different bypass switches.

Additionally, how a bypass switch of a bypass block is set, e.g., what determines which of the one or more bypass networks of the bypass block should be activated, may vary between embodiments. For example, in some embodiments the bypass switch of a bypass block may store and follow a set of instructions that instruct the bypass switch on which bypass networks are to be selected. In some embodiments this may involve the bypass switch of a bypass block having a default selection of one or more bypass networks of the bypass block.

In some embodiments, the bypass switch of a bypass block may be set by being instructed to select one or more bypass networks of the bypass block. This may involve, for example, a controller that is communicatively coupled with the bypass switch of a bypass block and that instructs the bypass switch on which bypass networks of the bypass block the bypass switch should select. In some embodiments, the controller may be part a component of a host system that the artificial neural network is implemented on. For example, the controller could be a dedicated hardware component of the host system. In other embodiments, the controller could be a program being ran on a processing unit of the host device, which could be a general processing unit, such as a central processing unit (CPU), a general-purpose graphics processing unit (GPGPU), or an embedded microcontroller or could be a hardware accelerator such as a graphics processing unit (GPU), a neural processing unit (NPU), a tensor processing unit (TPU), a field programmable gate array (FPGA), or an application-specific integrated circuit (ASIC).

In some embodiments, the controller could be part of a standalone electronic system that is dedicated to instantiating the artificial neural network. In some of these embodiments, the controller could be ran on/implemented on a component of the dedicated electronic system that is separate from the processing unit which instantiates the artificial neural network. The component could a general processing unit, such as a CPU, a GPGPU, or an embedded microcontroller or could be a hardware accelerator such as a GPU, an NPU, a TPU, an FPGA, or an ASIC. This component could also be dedicated to running or implementing the controller or could also run or implement other tasks. In some embodiments, the controller could be a program that is ran on the same processing unit as the artificial neural network. In some embodiments, the controller could be part of the artificial neural network itself (e.g., some artificial neurons or hidden layers of the artificial neural network are dedicated to instructing the bypass switches of the bypass blocks on which bypass networks should be selected). In some embodiments, there may also be more than one controller. In some embodiments with multiple controllers, the controllers could control different, non-overlapping subsets of bypass switches. In some embodiments, multiple controllers could control the same bypass switch.

Furthermore, how a bypass switch of a bypass block is set may simultaneously employ the variations discussed above. For example, a bypass switch could store and follow a set of instructions and could be instructed by a communicatively coupled controller. In some embodiments this may involve the bypass switch storing and following a set of instructions that the bypass switch defaults to if it has not been instructed by a controller, e.g., the bypass switch follows the stored set of instructions if it has not been instructed by a controller. In some embodiments, this may involve the bypass switch having a default selection of one or more bypass networks that is selects unless it has otherwise been instructed by a controller.

In some embodiments, instructing a bypass switch of a bypass block may involve receiving an electric signal. In other embodiments, instructing a bypass switch or a bypass block may involve passing a message between components of a program. In yet other embodiments, instructing a bypass switch of a bypass block may involve setting a value or flag. Additionally, in some embodiments, instructing a bypass switch to select a particular set of bypass networks may automatically cause the bypass switch to unselect any currently selected bypass networks. In some embodiments, a bypass switch may not automatically unselect any currently selected bypass network after being instructed to select a particular set of bypass networks. In some embodiments, the bypass network may be additionally instructed to unselect (e.g., deactivate/make non-activated) one or more bypass networks.

Also, the basis on which a bypass switch of a bypass block is set may vary between embodiments. For example, in some embodiments the bypass switch may be set based on a static strategy, such as the bypass switch being set to alternative between all available bypass networks in a bypass block. In other embodiments, the bypass block may be set on a dynamic strategy. For example, in some embodiments the bypass block may be set based on evaluations of the performance metrics of the artificial neural network. These performance metrics may comprise current measurables of the artificial neural network, such as the current elapsed execution time, the projected remaining execution time, the current power usage, the projected remaining power usage, the current total processing-time utilized, the projected remaining processing-time, the current total memory usage, the projected total memory usage, the current projected accuracy based on selected and active bypass networks, the predicted level of needed accuracy, or any other important metric related to the artificial neural network. Also, in some embodiments, the bypass switch may be set for batches of inputs, with the measurables of the inputs in a batch being aggregated together for determining how the bypass switch may be set.

For some embodiments, the performance metrics may comprise historical measurables of the artificial neural network, such as historical elapsed execution time for the current position, historical projected remaining execution time for the current position, the historical power usage for the current position, the historical projected remaining power usage for the current position, the historical total processing-time utilized for the current position, the historical projected remaining processing-time for the current position, the historical total memory usage for the current position, the historical projected total memory usage for this position, the historical projected accuracy based on selected and active bypass networks for the current position, the historical predicted level of needed accuracy for the current input, or any other important historical metric related to the artificial neural network. Additionally, these historical metrics may be based on the input being processed alone, rather than the current state of the artificial neural network in processing the input. Also, in some embodiments a combination of current and historical measurables may comprise the performance metrics.

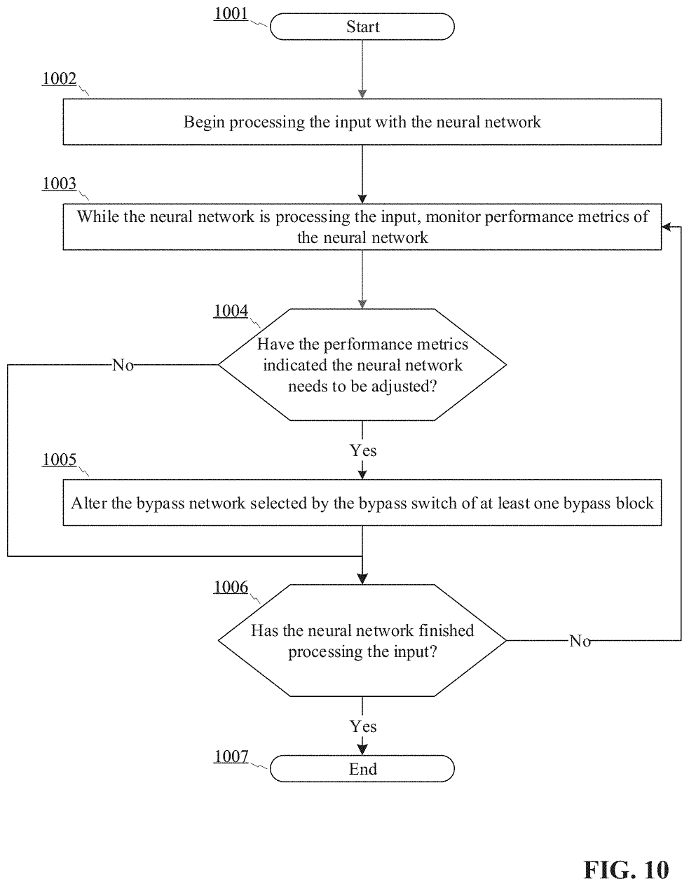

FIG. 10 is a flowchart of an exemplary method for how an artificial neural network may change a selected bypass network based on monitored performance metrics. As shown by FIG. 10, in step 1002, processing of an input with the artificial neural network begins. Then, in step 1003, monitoring of performance metrics of the artificial neural network begins. In step 1004, it is determined if the performance metrics of the artificial neural network have indicated the artificial neural network needs to be adjusted. If the performance metrics of the artificial neural network have indicated the artificial neural network needs to be adjusted, in step 1005, the bypass network (e.g., bypass network 510 of FIG. 5, bypass network 602 of FIG. 6, or bypass network 704 of FIG. 7) selected by the bypass switch (e.g., bypass switch 501 of FIG. 5, bypass switch 601 of FIG. 6, or bypass switch 702 of FIG. 7) of at least one bypass block is altered (e.g., bypass block 802 of FIG. 8 or bypass block 902 of FIG. 9). Step 1005 then proceeds to step 1006. On the other hand, if in step 1004 it is determined that the performance metrics of the artificial neural network have not indicated the artificial neural network needs to be adjusted the method proceeds to step 1006, where it is determined if the artificial neural network has finished processing the input. If the artificial neural network has finished processing the input, the method returns to step 1003. If the artificial neural network has not finished processing the input, the method ends.

How the performance characteristics are monitored may vary. The performance metrics may be monitored, for example by a host system, by the artificial neural network, or by a component of the dedicated electronic system that the artificial neural network is implemented or being run on. In some embodiments, a combination of these systems may be used, e.g., some performance characteristics could be monitored by the host system, others could be monitored by the artificial neural network, and still others may be monitored by a component of the dedicated electronic system the artificial neural network is implemented on. In some embodiments, the monitored observables may be forwarded to anther electronic component, system, or location, such as the controller.

Additionally, in some embodiments the basis on which a bypass switch of a bypass block is set may be based on criteria of the device the artificial neural network is implemented on. For example, in some embodiments the bypass switch may be set based on observables such as what other inputs are currently waiting to be processed by the artificial neural network, what other tasks are currently pending that need to be performed, the resources available to the device, such as power-budget or network data-budget, the time constraints for processing the current input by the artificial neural network, the time constraints for response or processing of other inputs are pending tasks, the overall importance of the input currently being processed, or the overall importance of other inputs or pending tasks.

How the observables are monitored may vary. The observables may be monitored, for example, by a host system, by the artificial neural network, or by a component of the dedicated electronic system that the artificial neural network is implemented or being run on. In some embodiments, a combination of these systems may be used, e.g., some observables could be monitored by the host system, others could be monitored by the artificial neural network, and still others may be monitored by a component of the dedicated electronic system the artificial neural network is implemented on. In some embodiments, the monitored observables may be forwarded to anther electronic component, system, or location.

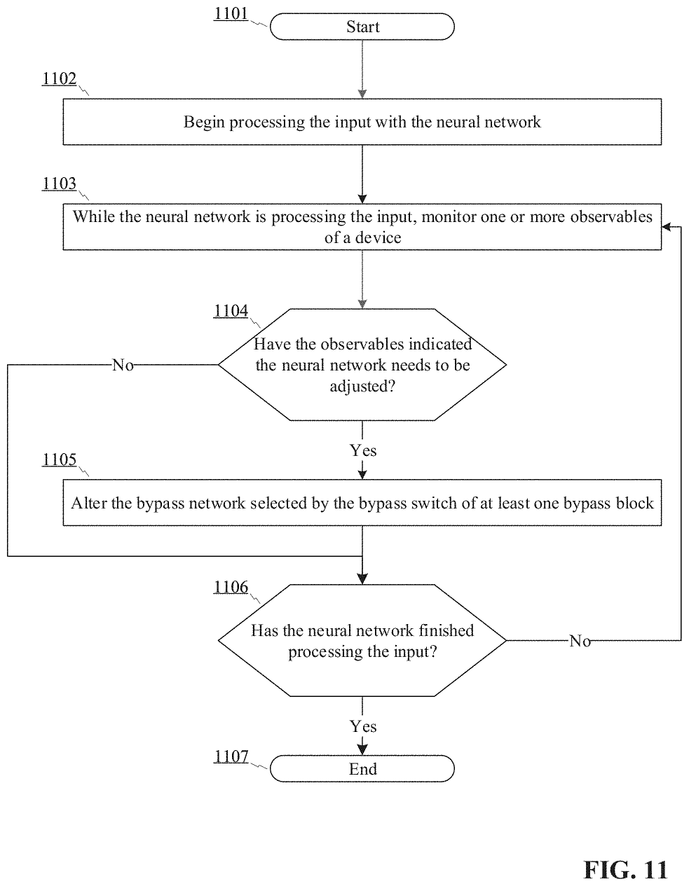

FIG. 11 is a flowchart of an exemplary method for how an artificial neural network may change a selected bypass network based one observables of a device. As shown by FIG. 11, in step 1102, processing of an input with the artificial neural network begins. Then, in step 1103, monitoring of observables of a device begins. In step 1104, it is determined if the observables have indicated the artificial neural network needs to be adjusted. If the observables have indicated that the artificial neural network needs to be adjusted, in step 1105 the bypass network (e.g., bypass network 510 of FIG. 5, bypass network 602 of FIG. 6, or bypass network 704 of FIG. 7) selected by the bypass switch (e.g., bypass switch 501 of FIG. 5, bypass switch 601 of FIG. 6, or bypass switch 702 of FIG. 7) of at least one bypass block (e.g., bypass block 802 of FIG. 8 or bypass block 902 of FIG. 9) is altered. Step 1105 then proceeds to step 1106. On the other hand, if in step 1104 it is determined that the observables have not indicated that the artificial neural network needs to be adjusted the method proceeds to step 1106, where it is determined if the artificial neural network has finished processing the input. If the artificial neural network has finished processing the input, the method returns to step 1103. If the artificial neural network has not finished processing the input, the method ends.

Also, in some embodiments a bypass switch of a bypass block could be set based on an event from outside the artificial neural network the host device. For example, in some embodiments the bypass switch could be set based on a user taking some action, such as pressing a button. This could be used, for example, for a user to indicate a desire for the device to use less accuracy so that the device would use less power and in turn produce less heat, which might allow a cooling fan of the device to slow down and produce less noise. Alternatively, a user could take some action to indicate a desire for the device to use more accuracy, perhaps at the cost of shorter battery life or more heat production.

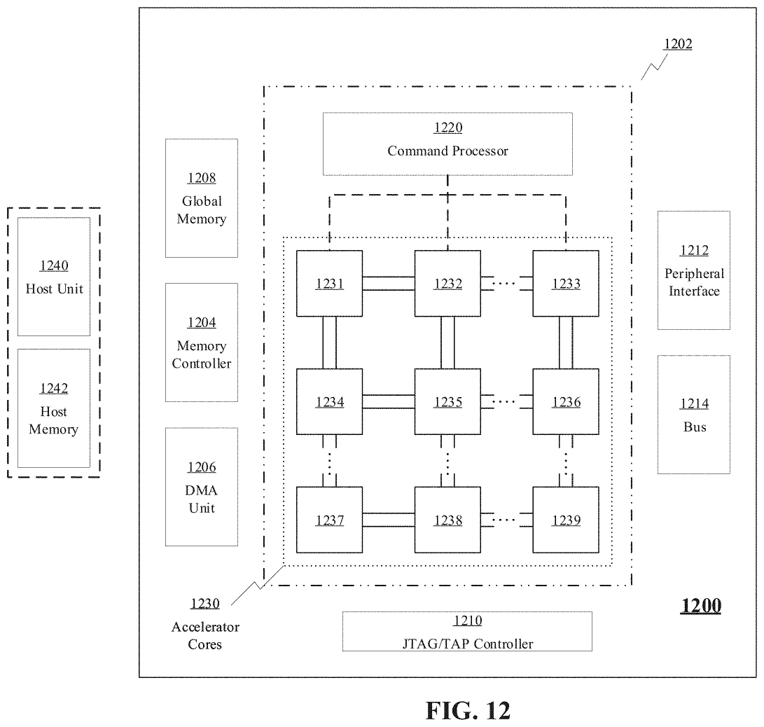

FIG. 12 is a schematic diagram illustrating an exemplary processing unit, according to some embodiments of the present disclosure. Specifically, FIG. 12 illustrates a neural network processing architecture 1200, which could be a processing unit of a host device, an accelerator unit for an artificial neural network, an FPGA or a variety of other devices and systems. As shown by FIG. 12, accelerator unit 1200 can include an accelerator processing system 1202, a memory controller 1204, a direct memory access (DMA) unit 1206, a global memory 1208, a Joint Test Action Group (JTAG)/Test Access End (TAP) controller 1210, a peripheral interface 1212, a bus 1214, and the like. It is appreciated that, accelerator processing system 1202 can perform algorithmic operations (e.g., machine learning operations) based on communicated data.

Accelerator processing system 1202 can include a command processor 1220 and a plurality of accelerator cores 1230. Command processor 1220 may act to control and coordinate one or more accelerator cores, shown here as accelerator cores 1231, 1232, 1233, 1234, 1235, 1236, 1237, 1238, and 1239. Each of the accelerator cores 1230 may provide a subset of the synapse/neuron circuitry for parallel computation (e.g., the artificial neural network). For example, the first layer of accelerator cores 1230 of FIG. 12 may provide circuitry representing an input layer to an artificial neural network, while the second layer of accelerator cores 1230 may provide circuitry representing a hidden layer of the artificial neural network. In some embodiments, accelerator processing system 1202 can be implemented as one or more GPUs, NPUs, TPUs, FPGAs, ASICs, or other heterogeneous accelerator units.

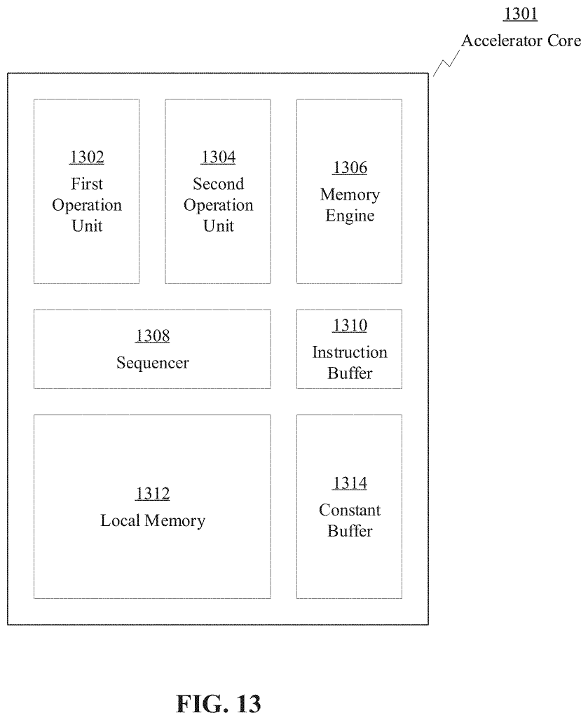

Accelerator cores 1230, for example, can include one or more processing elements that each include single instruction, multiple data (SIMD) architecture including one or more processing units configured to perform one or more operations (e.g., multiplication, addition, multiply-accumulate, etc.) based on instructions received from command processor 1220. To perform the operation on the communicated data packets, accelerator cores 1230 can include one or more processing elements for processing information in the data packets. Each processing element may comprise any number of processing units. In some embodiments, accelerator cores 1230 can be considered a tile or the like. In some embodiments, the plurality of accelerator cores 1230 can be communicatively coupled with each other. For example, the plurality of accelerator cores 1230 can be connected with a single directional ring bus, which supports efficient pipelining for large neural network models. The architecture of accelerator cores 1230 will be explained in detail with respect to FIG. 13.

Accelerator processing architecture 1200 can also communicate with a host unit 1240. Host unit 1240 can be one or more processing unit (e.g., an X86 central processing unit). As shown in FIG. 2A, host unit 1240 may be associated with host memory 1242. In some embodiments, host memory 1242 may be an internal memory or an external memory associated with host unit 1240. In some embodiments, host memory 1240 may comprise a host disk, which is an external memory configured to provide additional memory for host unit 1240. Host memory 1242 can be a double data rate synchronous dynamic random-access memory (e.g., DDR SDRAM) or the like. Host memory 1242 can be configured to store a large amount of data with slower access speed, compared to the on-chip memory integrated within one or more processors, acting as a higher-level cache. The data stored in host memory 1242 may be transferred to accelerator processing architecture 200 to be used for executing neural network models.

In some embodiments, a host system having host unit 1240 and host memory 1242 can comprise a compiler (not shown). The compiler is a program or computer software that transforms computer codes written in one programming language into NPU instructions to create an executable program. In machine learning applications, a compiler can perform a variety of operations, for example, pre-processing, lexical analysis, parsing, semantic analysis, conversion of input programs to an intermediate representation, code optimization, and code generation, or combinations thereof. For example, the compiler can compile a neural network to generate static parameters, e.g., connections among neurons and weights of the neurons.

In some embodiments, the host system 1240 may push one or more commands to accelerator processing system 1202. As discussed above, these commands can be further processed by command processor 1220 of accelerator processing system 1202, temporarily stored in an instruction buffer of accelerator processing architecture 200, and distributed to one or more corresponding accelerator cores (e.g., accelerator cores 1231 and 1232) or processing elements. Some of the commands can instruct DMA unit 1206 to load the instructions (generated by the compiler) and data from host memory 1242 into global memory 1208. The loaded instructions may then be distributed to each accelerator core assigned with the corresponding task, and the one or more accelerator cores can process these instructions.

It is appreciated that the first few instructions received by the accelerator cores 1230 may instruct the accelerator cores 1230 to load/store data from host memory 1242 into one or more local memories of the accelerator cores (e.g., local memory 1312 of FIG. 13). Each of the accelerator cores 1230 may then initiate the instruction pipeline, which involves fetching the instruction (e.g., via a sequencer) from the instruction buffer, decoding the instruction (e.g., via a DMA unit 1206), generating local memory addresses (e.g., corresponding to an operand), reading the source data, executing or loading/storing operations, and then writing back results.

Command processor 1220 can interact with the host unit 1240 and pass pertinent commands and data to accelerator processing system 1202. In some embodiments, command processor 1220 can interact with host unit 1240 under the supervision of kernel mode driver (KMD). In some embodiments, command processor 1220 can modify the pertinent commands to each accelerator core, so that accelerator cores 1230 can work in parallel as much as possible. The modified commands can be stored in an instruction buffer. In some embodiments, command processor 1220 can be configured to coordinate one or more accelerator cores for parallel execution.

Memory controller 1204 can manage the reading and writing of data to and from a specific memory block within global memory 1208 having on-chip memory blocks (e.g., blocks of second generation of high bandwidth memory (HBM2)) to serve as main memory. For example, memory controller 1204 can manage read/write data coming from outside accelerator processing system 1202 (e.g., from DMA unit 1206 or a DMA unit corresponding with another NPU) or from inside accelerator processing system 1202 (e.g., from a local memory in an accelerator core, such as accelerator core 1231, via a 2D mesh controlled command processor 1220). Moreover, while one memory controller is shown in FIG. 12, it is appreciated that more than one memory controller can be provided in accelerator unit 1200. For example, there can be one memory controller for each memory block (e.g., HBM2) within global memory 1208. In some embodiments, global memory 1208 can store instructions and data from host memory 1242 via DMA unit 1206. The instructions can then be distributed to an instruction buffer of each accelerator core assigned with the corresponding task, and the accelerator core can process these instructions accordingly.

Memory controller 1204 can generate memory addresses and initiate memory read or write cycles. Memory controller 1204 can contain several hardware registers that can be written and read by the one or more processors. The registers can include a memory address register, a byte-count register, one or more control registers, and other types of registers. These registers can specify some combination of the source, the destination, the direction of the transfer (reading from the input/output (I/O) device or writing to the I/O device), the size of the transfer unit, the number of bytes to transfer in one burst, and/or other typical features of memory controllers.

DMA unit 1206 can assist with transferring data between host memory 1242 and global memory 1208. For example, DMA unit 1206 can assist with loading data or instructions from host memory 1242 into local memory of accelerator cores 1230. DMA unit 1206 can also assist with transferring data between multiple accelerators. In addition, DMA unit 1206 can assist with transferring data between multiple NPUs (e.g., accelerator processing system 1202 implemented on an NPU). For example, DMA unit 1206 can assist with transferring data between multiple accelerator cores 1230 or within each accelerator core. DMA unit 1206 can allow off-chip devices to access both on-chip and off-chip memory without causing a CPU interrupt. Thus, DMA unit 1206 can also generate memory addresses and initiate memory read or write cycles. DMA unit 1206 also can contain several hardware registers that can be written and read by the one or more processors, including a memory address register, a byte-count register, one or more control registers, and other types of registers. These registers can specify some combination of the source, the destination, the direction of the transfer (reading from the I/O device or writing to the I/O device), the size of the transfer unit, and/or the number of bytes to transfer in one burst. It is appreciated that accelerator unit 1200 can include a second DMA unit, which can be used to transfer data between other neural network processing architectures to allow multiple neural network processing architectures to communication directly without involving the host CPU.

JTAG/TAP controller 1210 can specify a dedicated debug port implementing a serial communications interface (e.g., a JTAG interface) for low-overhead access to the NPU without requiring direct external access to the system address and data buses. JTAG/TAP controller 1210 can also have on-chip test access interface (e.g., a TAP interface) that implements a protocol to access a set of test registers that present chip logic levels and device capabilities of various parts.

Peripheral interface 1212 (such as a peripheral component interconnect express (PCIe) interface), if present, serves as an (and typically the) inter-chip bus, providing communication between accelerator unit 1200 and other devices. Bus 1214 (such as a I²C bus) includes both intra-chip bus and inter-chip buses. The intra-chip bus connects all internal components to one another as called for by the system architecture. While not all components are connected to every other component, all components do have some connection to other components they need to communicate with. The inter-chip bus connects the NPU with other devices, such as the off-chip memory or peripherals. For example, bus 1214 can provide high speed communication across accelerator cores and can also connect accelerator cores 1230 (via accelerator processing system 1202) with other units, such as the off-chip memory or peripherals. Typically, if there is a peripheral interface 1212 (e.g., the inter-chip bus), bus 1214 is solely concerned with intra-chip buses, though in some implementations it could still be concerned with specialized inter-bus communications.

Accelerator processing system 1202 can be configured to perform operations based on artificial neural networks. While accelerator processing architecture 200 can be used for convolutional neural networks (CNNs) in some embodiments of the present disclosure, it is appreciated that accelerator processing architecture 200 can be utilized in various neural networks, such as deep neural networks (DNNs), recurrent neural networks (RNNs), or the like. In addition, some embodiments can be configured for various processing architectures, such as CPUs, GPGPUs, GPUs, NPUs, TPUs, FPGAs, ASICs, any other types of heterogeneous accelerator processing units (HAPUs), or the like.

In operation, an artificial neural network, according to some embodiments of the present disclosure, may be transferred from host memory 1242 to the accelerator unit 1200 using the DMA unit 1206. The host unit 1240 may be connected to the accelerator unit 1200 via Peripheral interface 1212. In some embodiments, the artificial neural network and intermediate values of the artificial neural network may be stored in global memory 1208 which is controlled by memory controller 1204. Finally, artificial neural networks by be ran on the AI processor 1202, with command processor 1220 managing the processing of an input with an artificial neural network.

FIG. 13 illustrates an exemplary accelerator core architecture, according to some embodiments of the present disclosure. As shown in FIG. 13, accelerator core 1301 (e.g., accelerator cores 1230 of FIG. 12) can include one or more operation units such as first unit 1302 and second operation unit 1304, a memory engine 1306, a sequencer 1308, an instruction buffer 1310, a constant buffer 1314, a local memory 1312, or the like.

One or more operation units can include first operation unit 1302 and second operation unit 1304. First operation unit 1302 can be configured to perform operations on received data (e.g., matrices). In some embodiments, first operation unit 1302 can include one or more processing units configured to perform one or more operations (e.g., multiplication, addition, multiply-accumulate, element-wise operation, etc.). In some embodiments, first operation unit 1302 is configured to accelerate execution of convolution operations or matrix multiplication operations. Second operation unit 1304 can be configured to perform a pooling operation, an interpolation operation, a region-of-interest (ROI) operation, and the like. In some embodiments, second operation unit 1304 can include an interpolation unit, a pooling data path, and the like.

Memory engine 1306 can be configured to perform a data copy within a corresponding accelerator core 1301 or between two accelerator cores. DMA unit 208 can assist with copying data within a corresponding accelerator core 1301 or between two accelerator cores. For example, DMA unit 208 can support memory engine 1306 to perform data copy from a local memory (e.g., local memory 1312 of FIG. 13) into a corresponding operation unit. Memory engine 1306 can also be configured to perform matrix transposition to make the matrix suitable to be used in the operation unit.

Sequencer 1308 can be coupled with instruction buffer 1310 and configured to retrieve commands and distribute the commands to components of accelerator core 1301. For example, sequencer 1308 can distribute convolution commands or multiplication commands to first operation unit 1302, distribute pooling commands to second operation unit 1304, or distribute data copy commands to memory engine 1306. Sequencer 1308 can also be configured to monitor execution of a neural network task and parallelize sub-tasks of the neural network task to improve efficiency of the execution. In some embodiments, first operation unit 1302, second operation unit 1304, and memory engine 1306 can run in parallel under control of sequencer 1308 according to instructions stored in instruction buffer 1310.

Instruction buffer 1310 can be configured to store instructions belonging to the corresponding accelerator core 1301. In some embodiments, instruction buffer 1310 is coupled with sequencer 1308 and provides instructions to the sequencer 1308. In some embodiments, instructions stored in instruction buffer 1310 can be transferred or modified by command processor 204. Constant buffer 1314 can be configured to store constant values. In some embodiments, constant values stored in constant buffer 1314 can be used by operation units such as first operation unit 1302 or second operation unit 1304 for batch normalization, quantization, de-quantization, or the like.

Local memory 1312 can provide storage space with fast read/write speed. To reduce possible interaction with a global memory, storage space of local memory 1312 can be implemented with large capacity. With the massive storage space, most of data access can be performed within accelerator core 1301 with reduced latency caused by data access. In some embodiments, to minimize data loading latency and energy consumption, static random-access memory (SRAM) integrated on chip can be used as local memory 1312. In some embodiments, local memory 1312 can have a capacity of 192 MB or above. According to some embodiments of the present disclosure, local memory 1312 be evenly distributed on chip to relieve dense wiring and heating issues.

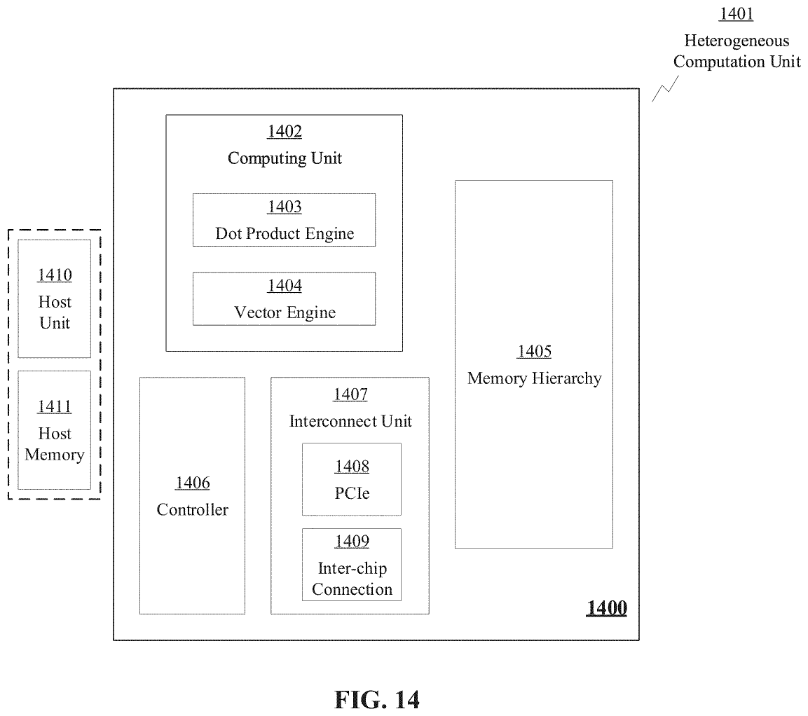

FIG. 14 is a diagram illustrating an alternative exemplary processing unit to the exemplary processing unit illustrated in FIG. 12. Like the exemplary processing unit in FIG. 12, FIG. 14 illustrates a neural network processing architecture 1400 that some embodiments of the present disclosure may be implemented on. In various embodiments, neural network processing architecture 1400 could be a processing unit of a host device, an accelerator unit for an artificial neural network, an FPGA or a variety of other devices and systems. As shown in FIG. 14, architecture 1400 can include a heterogeneous computation unit (HCU) 1401 and a corresponding host unit 1410 and host memory 1411, and the like. It is appreciated that, HCU 1401 can be a special-purpose computing device for facilitating neural network computing tasks. For example, HCU 1401 can perform algorithmic operations (e.g., machine learning operations) based on communicated data. HCU 1401 can be an accelerator, such as a GPU, an NPU, a TPU, an FPGA, an ASIC, or the like.

HCU 1401 can include one or more computing units 1402, a memory hierarchy 1405, a controller 1406 and an interconnect unit 1407. Each computing unit 1402 can read data from and write data into memory hierarchy 1405, and perform algorithmic operations (e.g., multiplication, addition, multiply-accumulate, etc.) on the data. In some embodiments, computing unit 1402 can include a plurality of engines for performing different operations. For example, as shown in FIG. 14, computing unit 1402 can include a dot product engine 1403, a vector engine 1404, and the like. Dot product engine 1403 can perform dot product operations such as multiplication and convolution. Vector engine 1404 can perform vector operations such as addition.

Memory hierarchy 1405 can have on-chip memory blocks (e.g., 4 blocks of HBM2) to serve as main memory. Memory hierarchy 1405 can store data and instructions, and provide other components, such as computing unit 1402 and interconnect 1407, with high speed access to the stored data and instructions. Interconnect unit 1407 can communicate data between HCU 1402 and other external components, such as host unit or another HCU. Interconnect unit 1407 can include a PCIe interface 1408 and an inter-chip connection 1409. PCIe interface 1408 provides communication between HCU and host unit 1410 or Ethernet. Inter-chip connection 1409 servers as an inter-chip bus, connecting the HCU with other devices, such as other HCUs, the off-chip memory or peripherals.

Controller 1406 can control and coordinate the operations of other components such as computing unit 1402, interconnect unit 1407 and memory hierarchy 1405. For example, controller 1406 can control dot product engine 1403 or vector engine 1404 in computing unit 1402 and interconnect unit 1407 to facilitate the parallelization among these components.

Host memory 1411 can be off-chip memory such as a host CPU's memory. For example, host memory 1411 can be a DDR memory (e.g., DDR SDRAM) or the like. Host memory 1411 can be configured to store a large amount of data with slower access speed, compared to the on-chip memory integrated within one or more processors, acting as a higher-level cache. Host unit 1410 can be one or more processing units (e.g., an X86 CPU). In some embodiments, a host system having host unit 1410 and host memory 1411 can comprise a compiler (not shown). The compiler is a program or computer software that transforms computer codes written in one programming language into instructions for HCU 1401 to create an executable program. In machine learning applications, a compiler can perform a variety of operations, for example, pre-processing, lexical analysis, parsing, semantic analysis, conversion of input programs to an intermediate representation, code optimization, and code generation, or combinations thereof.

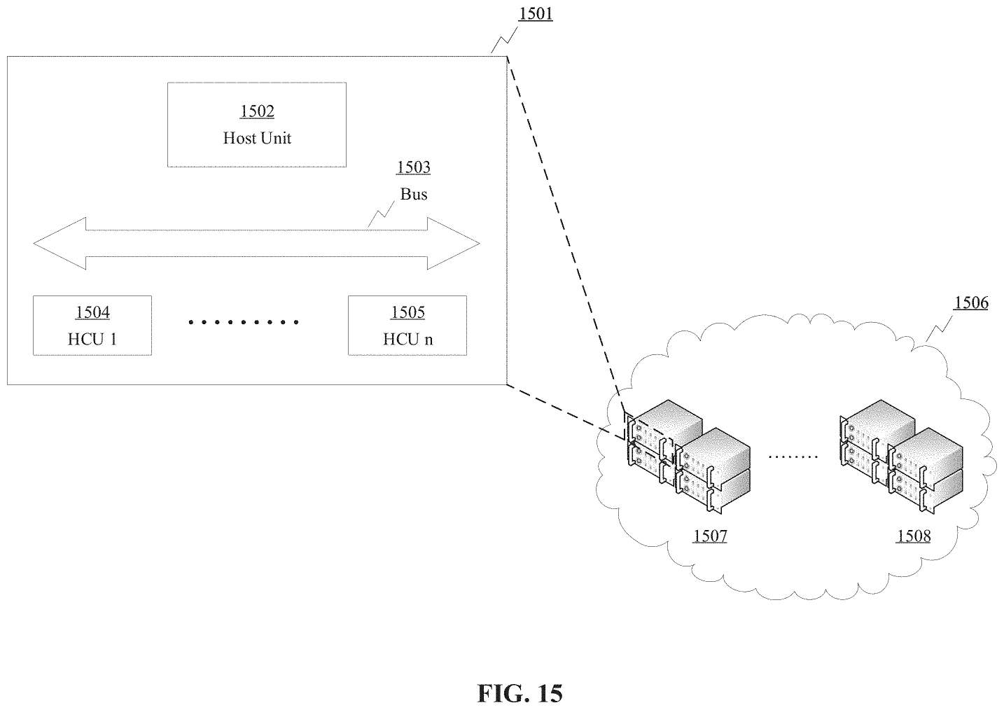

FIG. 15 illustrates a schematic diagram of an exemplary cloud system 1506 incorporating neural network processing architecture 1501, according to embodiments of the present disclosure. As shown in FIG. 15, cloud system 1506 can provide cloud service with artificial intelligence (AI) capabilities and can include a plurality of computing servers (e.g., computing servers 1507 and 1508). In some embodiments, a computing server 1507 can, for example, incorporate neural network processing architectures 1200 (FIG. 12) or 1400 (FIG. 14). Neural network processing architecture 1501 is shown in FIG. 15 as a simplified version of neural network processing architecture 1400 for simplicity and clarity.

With the assistance of neural network processing architecture 1400, cloud system 1506 can provide the extended AI capabilities of image recognition, facial recognition, translations, 3D modeling, and the like. It is appreciated that, neural network processing architecture 1400 can be deployed to computing devices in other forms. For example, neural network processing architecture 1400 can also be integrated in a computing device, such as a smart phone, a tablet, and a wearable device. Moreover, while a specific architecture is shown in FIGS. 12-15, it is appreciated that any HCU or any accelerator that provides the ability to perform parallel computation can be used.

In some embodiments, only one bypass network within a bypass block may be simultaneously active. In some of these embodiments, a bypass switch of a bypass block may simultaneously select only one bypass network within the bypass block. In other embodiments, multiple bypass networks within a bypass block may be simultaneously active, and in some of these embodiments a bypass switch of a bypass block may simultaneously select multiple bypass networks within the bypass block. In some embodiments where multiple bypass networks may be simultaneously active, a scheme to combine the output of the active bypass networks may be used. For example, the outputs of the active bypass networks could be averaged together. In some embodiments, multiple bypass blocks may follow both strategies, e.g., some bypass blocks may have only one bypass network simultaneously active while other bypass bocks may have multiple bypass networks simultaneously active.

Additionally, in some embodiments the plurality of hidden layers may be composed of a plurality of artificial neurons. In some embodiments, each artificial neuron may have one or more incoming connections. In some embodiments, each of these connections may have a weight associated with the connection. This weight may control the strength of the connection and may be represented by a number, which could, in some embodiments, be a real number, an integer, a fraction, a rational number, or some other type of data. In some embodiments, the incoming connections to an artificial neuron may convey signals. The signals could, in some embodiments, be represented by a real number, an integer, a fraction, a rational number, or some other type of data.

In some embodiments, each artificial neuron may have one or more outgoing connections. In some embodiments, the one or more outgoing connections may act as incoming connections for other artificial neurons. In some embodiments, each artificial neuron may provide an outgoing signal. Some embodiments may generate the outgoing signal based on the incoming signals to the artificial neuron. In some embodiments, this may be accomplished by using the incoming signals as the input to an activation function. For example, in some embodiments, each plurality of artificial neurons may multiply any incoming signals by the weight associated with the corresponding connection. In some of these embodiments, each plurality of artificial neuron may further sum the product obtained from multiplying the signals by their corresponding weights together. Next, the artificial neurons may, in some embodiments, use the resulting sum as the input the artificial neurons' activation functions. Also, in some of these embodiments the result of the activation function may be used as the outgoing signal for that artificial neuron. Finally, the activation function used by the artificial neurons may vary. For example, the activation functions used in some embodiments may be a binary step function, a linear function, a sigmoid function, a tan h function, a ReLU function, a leaky ReLU function, or a softmax function.

The artificial neural network may also be a variety of types of artificial neural networks. For example, in some embodiments the artificial neural network could be a perceptron, a feed forward neural network, a radial bias network, a deep feed forward network, a recurrent neural network, a long/short term memory neural network, a gated recurrent unit neural network, an auto encoder neural network, a variational auto encoder neural network, a denoising auto encoder neural network, a sparse auto encoder neural network, a Markov chain neural network, a Hopfield neural network, a Boltzmann machine neural network, a restricted Boltzmann machine neural network, a deep belief network, a deep convolutional network, a deconvolutional network, a deep convolutional inverse graphics network, a generative adversarial network, a liquid state machine neural network, an extreme learning machine neural network, an echo state network, a deep residual network, a Kohonen network, a support vector machine neural network, or a neural Turing machine.

Additionally, the artificial neural network may be implemented and represented in a variety of ways. For example, in some embodiments, the artificial neural network may be implemented in software. In some of these embodiments, an artificial neural network may be represented in software as several matrixes. In other embodiments, an artificial neural network may be represented in software via some other data structure. Rather than be implemented in software, in some embodiments the artificial neural network may be implemented in hardware. For example, in some embodiments the artificial neural network may be represented in hardware as the physical connections between transistors.

Additionally, an artificial neural network may be instantiated on (e.g., ran on) a variety of processing units. In general, a processing unit could be any device, system, or technology capable of computation. For example, in some embodiments the processing unit the artificial neural network is implemented on, executed on, or instantiated on may be a general processing unit, such as a CPU, GPGPU, or an embedded microcontroller. In other embodiments, the processing unit the artificial neural network is instantiated on may be a hardware accelerator such as a GPU, an NPU, a TPU, an FPGA, or an ASIC.

In some embodiments, the artificial neural network may be hosted on a standalone electronic system, e.g., the artificial neural network may be executed on a dedicated electronic device. In other embodiments, the artificial neural network may be hosted on a host system, which could be a variety of electronic devices. For example, the host system hosting an artificial neural network could be a server, one or more nodes in a datacenter, a desktop computer, a laptop computer, a tablet, a smartphone, a wearable device such as a smartwatch, an embedded device, an IoT device, a smart device, a sensor, an orbital satellite, or any other electronic device capable of computation. Additionally, the artificial neural network can be hosted (e.g., instantiated in a host system) in a variety of ways. For example, in some embodiments the artificial neural network may be instantiated on a general processing unit of the host system, such as a CPU, GPGPU, or an embedded microcontroller. In other embodiments, the artificial neural network may be instantiated on a hardware accelerator of the host system, such as a GPU, an NPU, a TPU, an FPGA, or an ASIC. In some embodiments, the hardware accelerator of the host system may be dedicated to instantiating any artificial neural networks. In some embodiments, the hardware accelerator of the host system may be dedicated to only a particular artificial neural network. In other embodiments, the hardware accelerator of the host system may not be dedicated to either artificial neural networks generally or the artificial neural network specifically.

The host system may also contain a variety of electronic components. For example, in some embodiments the host system may contain one or more processing units, which, in general, could be any device, system, or technology capable of computation. For example, in some embodiments the host system may contain a processing unit that is a general processing unit, such as a CPU, GPGPU, or an embedded microcontroller. In other embodiments, the host system may contain a processing unit which is a hardware accelerator such as a GPU, an NPU, a TPU, an FPGA, or an ASIC.

Additionally, in some embodiments the artificial neural network may be distributed and ran across multiple devices or host systems. For example, various parts of an artificial neural network could be hosted and ran across multiple servers of a datacenter, which may allow parallel processing of the artificial neural network. As another example, multiple IoT devices could coordinate and distribute the task of hosting an artificial neural network to process and input between themselves. The multiple devices may be connected to one another, and in some embodiments the connections between the multiple devices could be physical, such as through a USB, Thunderbolt, InfiniBand, Fibre Channel, SAS, or SATA connections. Alternatively, in other embodiments some or all of the connections between the multiple devices could be over a network, such as Wi-Fi.

Some embodiments of the present disclosure may enable training an artificial neural network with at least one bypass block. This may be used, for example, to ensure that an artificial neural network that uses a bypass block maintains a reasonable level of accuracy for any combination of selected bypass networks of the one or more bypass blocks. To enable training of an artificial neural network with at least one bypass block, some embodiments of the present disclosure may begin training an artificial neural network with a training method. In some embodiments, this may involve training the artificial neural network using stochastic gradient descent or a variant or training the artificial neural network using genetic algorithms or evolutionary methods, among others.

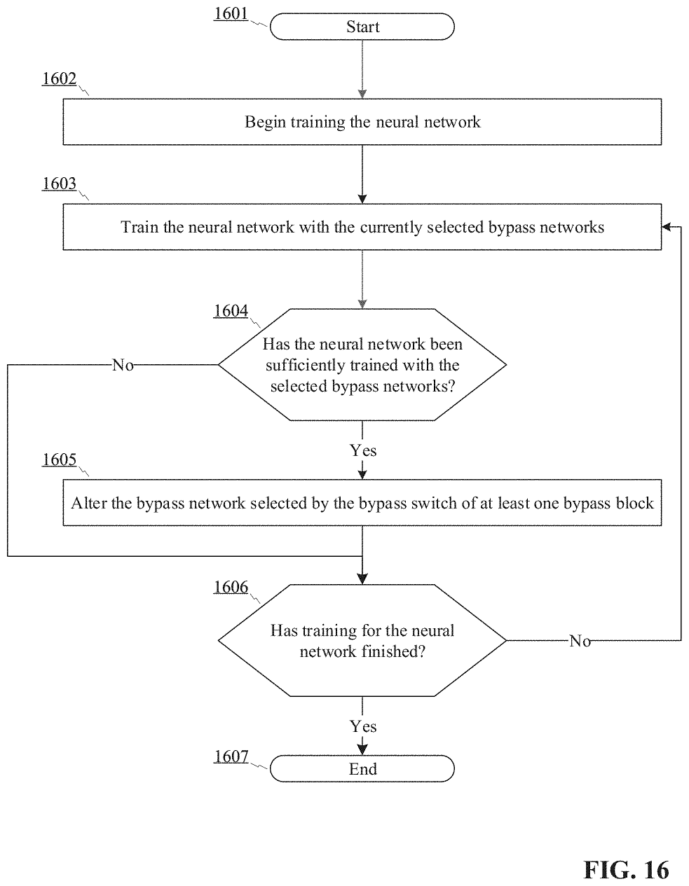

FIG. 16 is a flowchart of an exemplary method for how an artificial neural network with at least one bypass block may be trained. As shown by FIG. 16, in step 1602, training of an artificial neural network begins. Then, in step 1603, the artificial neural network is trained with the currently selected bypass networks of the bypass blocks of the artificial neural network. In step 1604, it is determined if the artificial neural network has been sufficiently trained with the currently selected bypass networks. If the artificial neural network has been sufficiently trained with the currently selected bypass networks, in step 1605 the bypass network (e.g., bypass network 510 of FIG. 5, bypass network 602 of FIG. 6, or bypass network 704 of FIG. 7) selected by the bypass switch (e.g., bypass switch 501 of FIG. 5, bypass switch 601 of FIG. 6, or bypass switch 702 of FIG. 7) of at least one bypass block (e.g., bypass block 802 of FIG. 8 or bypass block 902 of FIG. 9) is altered. Step 1605 then proceeds to step 1606. On the other hand, if in step 1604 it is determined that the artificial neural network has not been sufficiently trained with the currently selected bypass networks, the method proceeds to step 1606, where it is determined if the artificial neural network training has finished. If the artificial neural network training has not finished, the method returns to step 1603. If the artificial neural network training has finished, the method ends.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The devices, modules, and other functional units described in this disclosure can be implemented by hardware, or software, or a combination of hardware and software. One of ordinary skill in the art will also understand that the above described devices, modules, and other functions units may be combined or may be further divided into a plurality of sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. An artificial neural network system, the system comprising:
one or more processing units configured to instantiate a neural network comprising a bypass switch that is associated with at least two bypass networks, wherein each of the at least two bypass networks have at least one hidden layer, the bypass switch is configured to select a bypass network of the at least two bypass networks to activate, and any non-selected bypass network of the at least two bypass networks is not activated.

2. The system of claim 1, wherein the any non-selected bypass networks include hidden layers that are configured to not be used until the corresponding non-selected bypass network is activated.

3. The system of claim 1, wherein the bypass switch is configured to have a default selection to activate a bypass network of the at least two bypass networks.

4. The system of claim 1, further comprising a controller configured to instruct the bypass switch to select a bypass network of the at least two bypass networks to be activated.

5. The system of claim 4, wherein the controller comprises the one or more processing units.

6. The system of claim 4, wherein:
the controller is configured to monitor one or more performance metrics of the neural network wherein the instructions to select a bypass network is based on the monitored performance metrics.

7. The system of claim 6, wherein at least one of the one or more performance metrics are:
current power consumption,
current elapsed time processing the input,
current elapsed processing-time utilized,
current memory usage,
projected power consumption until the input is processed,
projected time remaining until the input is processed,
projected reaming processing-time until the input is processed, or
projected memory usage until the input is processed.

8. The system of claim 4, wherein:
the controller is configured to monitor one or more observables of a device, wherein the instructions to select a bypass network is based on the one or more observables.

9. The system of claim 8, wherein at least one of the one or more observable are:
current energy-budget of the device,
current charge of the battery of the device,
currently pending inputs waiting to be processed,
current available processing-time,
current available memory,
time constraints for processing the current input, or
time constraints for processing any pending inputs.

10. The system of claim 9, wherein the neural network is implemented on the device.

11. The system of claim 1, wherein the hidden layers of each bypass network of the at least two bypass networks are not connected to the hidden layers of any other bypass networks of the at least two bypass networks.

12. The system of claim 1, wherein only one of the at least two bypass networks is simultaneously activated.

13. A device employing an artificial neural network, the device comprising:
one or more processors; and
a memory unit connected with the one or more processors; and
a set of instructions stored on the memory unit that is executable by the one or more processors to cause the device to perform a method for performing inference with a neural network, the method comprising:
processing an input with a neural network comprising a bypass switch that is associated with at least two bypass networks, wherein each of the at least two bypass networks have at least one hidden layer, the bypass switch selects a bypass network of the at least two bypass networks to activate, and any non-selected bypass network of the at least two bypass networks is not activated; and
selecting, by the bypass switch, a bypass network of the at least two bypass networks.

14. The device of claim 13, wherein the any non-selected bypass networks include hidden layers that are configured to not be used until the corresponding non-selected bypass network is activated.

15. The device of claim 13, wherein the set of instructions is executable by the one or more processors to cause the device to further perform instructing the bypass switch to select a bypass network from the at least two bypass networks to be activated.

16. The device of claim 13, wherein the set of instructions is executable by the one or more processors to cause the device to further perform monitoring one or more performance metrics of the neural network, wherein the selection of a bypass network is based on the monitored performance metrics.

17. The device of claim 13, wherein the set of instructions is executable by the one or more processors to cause the device to further perform monitoring one or more observables of the device, wherein the selection of a bypass network is based on the monitored observables of the device.

18. The device of claim 13, wherein the hidden layers of each bypass network of the at least two bypass networks are not connected to the hidden layers of any other bypass networks of the at least two bypass networks.

19. The device of claim 13, wherein only one of the at least two bypass networks is simultaneously activated.

20. A method for performing inference with a neural network, the method comprising:
processing an input with a neural network comprising a bypass switch that is associated with at least two bypass networks, wherein each of the at least two bypass networks have at least one hidden layer, the bypass switch selects a bypass network of the at least two bypass networks to activate, and any non-selected bypass network of the at least two bypass networks is not activated; and
selecting, by the bypass switch, a bypass network of the at least two bypass networks.

21. The method of claim 20, wherein the any non-selected bypass networks include hidden layers that are configured to not be used until the corresponding non-selected bypass network is activated.

22. The method of claim 20, further comprising instructing the bypass switch to select a bypass network from the at least two bypass networks to be activated.

23. The method of claim 20, further comprising monitoring one or more performance metrics of the neural network, wherein the selection of a bypass network is based on the monitored performance metrics.

24. The method of claim 20, further comprising monitoring one or more observables of a device, wherein the selection of a bypass network is based on the monitored observables of the device.

25. The method of claim 20, wherein the hidden layers of each bypass network of the at least two bypass networks are not connected to the hidden layers of any other bypass networks of the at least two bypass networks.

26. The method of claim 20, wherein only one of the at least two bypass networks is simultaneously activated.

27. A non-transitory computer readable medium that stores a set of instructions that is executable by at least one processor of a computer system to cause the computer system to perform a method for performing inference with a neural network, the method comprising:
processing an input with a neural network comprising a bypass switch that is associated with at least two bypass networks, wherein each of the at least two bypass networks have at least one hidden layer, the bypass switch selects a bypass network of the at least two bypass networks to activate, and any non-selected bypass network of the at least two bypass networks is not activated; and
selecting, by the bypass switch, a bypass network of the at least two bypass networks.

28. The non-transitory computer readable medium of claim 27, wherein the any non-selected bypass networks include hidden layers that are configured to not be used until the corresponding non-selected bypass network is activated.

29. The non-transitory computer readable medium of claim 27, wherein the set of instructions is executable by the at least one processor of the computer system to cause the computer system to further perform instructing the bypass switch to select a bypass network from the at least two bypass networks to be activated.

30. The non-transitory computer readable medium of claim 27, wherein the set of instructions is executable by the at least one processor of the computer system to cause the computer system to further perform monitoring one or more performance metrics of the neural network, wherein the selection of a bypass network is based on the monitored performance metrics.

31. The non-transitory computer readable medium of claim 27, wherein the set of instructions is executable by the at least one processor of the computer system to cause the computer system to further perform monitoring one or more observables of a device, wherein the selection of a bypass network is based on the monitored observables of the device.

32. The non-transitory computer readable medium of claim 27, wherein the hidden layers of each bypass network of the at least two bypass networks are not connected to the hidden layers of any other bypass networks of the at least two bypass networks.

33. The non-transitory computer readable medium of claim 27, wherein only one of the at least two bypass networks is simultaneously activated.

34. A method for training a neural network, the method comprising:
training the neural network with a training method, the neural network comprising a bypass switch that is associated with at least two bypass networks, wherein each of the at least two bypass networks have at least one hidden layer, the bypass switch selects a bypass network of the at least two bypass networks to activate, and any non-selected bypass network of the at least two bypass networks is not activated; and
while the neural network is being trained with the training method, changing the bypass network selected by the bypass switch.

35. The method of claim 34, wherein changing the bypass network selected by the bypass switch is based on random selection.
